(19) United States
(12) Patent Application Publication
(10) Pub. No.: US 2017/0021755 A1
(43) Pub. Date: Jan. 26, 2017

(54) ARRANGEMENT OF A LOADING AREA INSIDE A MOTOR VEHICLE

(71) Applicant: RENAULT s.a.s., Boulogne Billancourt (FR)

(72) Inventors: Patrick BESSE, Boulogne (FR); Laurent CHELARD, Clamart (FR)

(73) Assignee: RENAULT s.a.s., Boulogne Billancourt (FR)

(21) Appl. No.: 15/100,138

(22) PCT Filed: Nov. 27, 2014
(86) PCT No.: PCT/EP2014/075810

§ 371 Date: Sep. 27, 2016

(30) Foreign Application Priority Data
Nov. 29, 2013 (FR) 1361883

(51) Int. Cl. B60P 7/08

(52) U.S. Cl. CPC B60P 7/0807; B60P 7/0823

(57) ABSTRACT

An arrangement of a loading area inside a motor vehicle includes a raised floor extending above a sheet-metal floor of the vehicle and at least one lashing device. The lashing device includes at least one attachment element to the raised floor. The attachment element is placed on the raised floor and includes a permanent magnet to occupy a first position in which the attachment element is attached to the raised floor by magnetization and a second position in which the attachment element is separated from the raised floor.

The invention relates to an arrangement of a loading area inside a motor vehicle.

Utility vehicles usually have a loading area including a raised floor arranged on the floor of the vehicle. Users of utility vehicles require the loading area to be practical both when loading and travelling, providing simple and effective means for lashing the items loaded.

However, raised floors, which are usually made of wood, make it difficult to move items by sliding. Furthermore, the lashing means usually have limited modularity and are complex to use.

Documents FR2774049 and DE4213821 describe lashing straps for transporting goods in a vehicle, in which the extremities have permanent magnets designed to cooperate with the metal walls of the vehicle. However, such devices have drawbacks. Since the permanent magnets have to be relatively powerful to ensure they do not become detached while the strap is holding the items, they are difficult for the user to remove. Furthermore, no specific arrangement of the floor has been provided to facilitate the loading of items.

In order to overcome these drawbacks, the invention relates to an arrangement of a loading area inside a motor vehicle that facilitates loading and provides simple, safe, modular lashing of the items loaded.

For this purpose, the invention describes an arrangement of a loading area of the type described above, characterized in that the loading area comprises a raised floor extending above a sheet-metal floor of the vehicle and at least one lashing means comprising at least one attachment element to the raised floor, the attachment element being designed to be placed on the raised floor and comprising a permanent magnet designed to occupy a first position in which the attachment element is attached to the raised floor by magnetization and a second position in which the attachment element is separated from the raised floor.

According to other features of the invention:
The attachment element includes:
a casing containing the magnet and having a horizontal upper wall extended by a substantially vertical lateral peripheral wall designed to be placed on the raised floor, and
a lever mounted rotatably between a high position and a low position and having a free extremity forming a gripping zone and second extremity linked to a first transverse shaft carried by the peripheral wall of the casing,
the permanent magnet having a first edge linked to the second extremity of the lever by means of a second transverse shaft and a second edge that is opposite the first edge and linked to the peripheral wall of the casing by means of a third transverse shaft such that, when the free extremity of the lever is turned upwards, a tractive force is applied to the second transverse shaft, thereby moving the magnet from the attached position, in which the lower face of same is in contact with the raised floor, to the separated position by means of a pivoting movement about the second edge of same and a raising of the first edge of same.
The attachment element includes means for locking the lever in the low position of same.
The casing has an opening designed to enable gripping means carried on the free extremity of the lever to pass through.
The lower edge of the peripheral wall of the casing has a rubber gasket that can be pressed against the raised floor when the attachment element is in the fixed position.
The lashing means are formed by a strap, the extremities of which are attached to an attachment element.
The casing includes hitching means for the extremity of the strap.
The casing includes a strap-winding mechanism.
The casing includes an orifice designed to receive a pin carried on the extremity of the strap.
The raised floor is made of a PTFE material designed to reduce adherence.
A metal plate is positioned between the raised floor and the floor.

Other features and advantages of the invention are set out in the description given below of example embodiments of a loading area arrangement inside a motor vehicle, with reference to the attached drawings, in which:

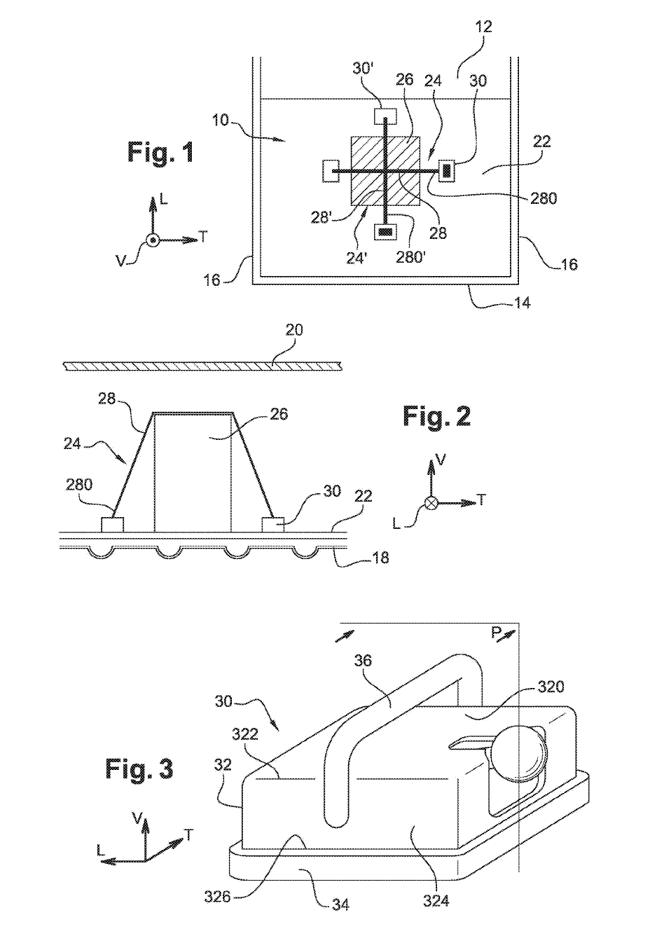

FIG. 1 is a schematic top view of a loading area according to the invention, containing an item,

FIG. 2 is a schematic front cross-sectional view of FIG. 1,

FIG. 3 is a detailed perspective view of the attachment element in FIGS. 1 and 2 according to a first embodiment,

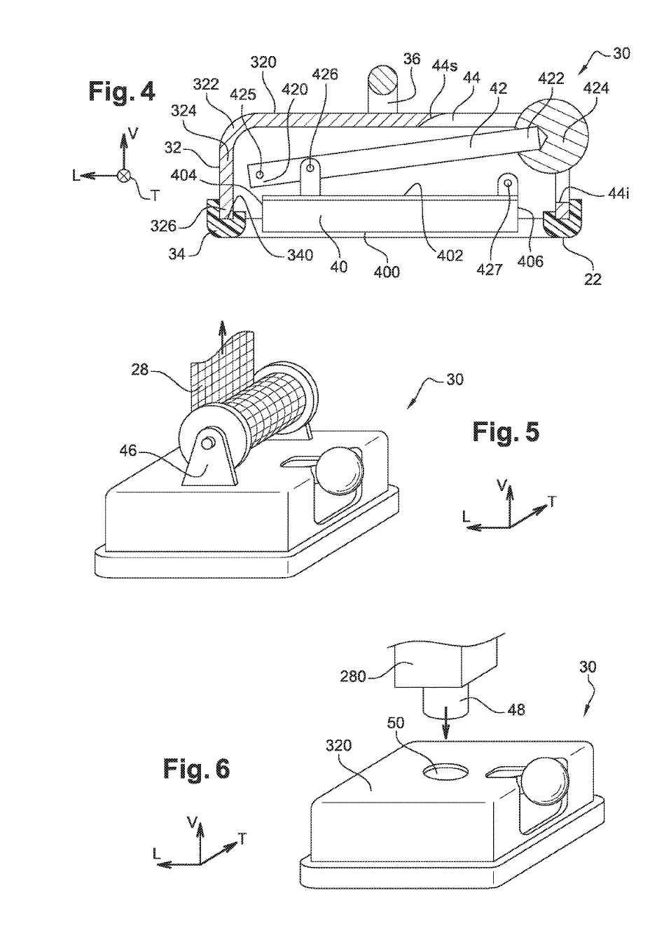

FIG. 4 is a cross-sectional view of the attachment element along the plane P in FIG. 3,

FIG. 5 is a detailed perspective view of the attachment element in FIGS. 1 and 2 according to a second embodiment,

FIG. 6 is a detailed perspective view of the attachment element in FIGS. 1 and 2 according to a third embodiment.

In the description below, non-limiting longitudinal, vertical and transversal orientation, indicated using the coordinate system L, V, T in FIGS. 1 to 6, shall be used.

Identical or similar elements are identified using the same reference signs.

As shown in FIGS. 1 and 2, a utility motor vehicle has a loading area 10 delimited by a row of seats 12, at least one rear transverse opening 14, side walls 16, a floor 18 and a roof 20.

The floor 18 is made of sheet metal.

The loading area 10 has a raised floor 22 arranged on the floor 18 of the vehicle and at least one lashing means 24 for an item 26.

The raised floor 22 is made of plastic and can be covered with a PTFE coating to facilitate the loading of items by allowing same to slide over the raised floor 22.

The lashing means 24 comprise a strap 28, the extremities 280 of which include an attachment element 30 to the raised floor 22.

The embodiment shown in FIG. 2 by way of nonlimiting example uses two lashing means 24 and 24′ arranged perpendicularly. The attachment elements 30 for the lashing means 24 are arranged on either side of the item 26, the strap 28 passing over the item 26.

The attachment elements 30′ of the second latching means 24′ are also arranged on either side of the item 26, but such that the strap 28′ passes over the item 26 and crosses the strap 28.

As shown in FIG. 3, the attachment element 30 has a casing 32 comprising a substantially horizontal upper wall 320, the edges 322 of which extend downwards into a substantially vertical peripheral side wall 324. In the embodiment described here, the shape of the casing is substantially parallelepipedic, but it could also be substantially cylindrical with a circular upper wall.

The free edge 326 of the peripheral wall 324 has a rubber gasket 34 designed to bear against the raised floor 22.

The gasket 34 has a groove 340 designed to be put on the free edge 326 of the peripheral wall 324.

The casing 32 also has a ring 36 extending from the horizontal wall 320 that is designed to receive one extremity 280, 280′ of the strap 28, 28′.

The extremity 280, 280′ of the strap 28, 28′ may be a loop or a hook.

As shown in FIG. 4, the casing 32 of the attachment element 30 contains a magnet 40 having a first face 400 designed to be placed on the upper face of the raised floor 22 and the second face 402 opposite the first phase 400 that is arranged opposite the horizontal wall 320 of the casing 32. In this case, the magnet 40 is substantially square and has a first face 404 and a second face 406 that are opposing and parallel.

The magnet 40 is mounted movably between an attached position in which the face 400 of same is in contact with the upper face of the raised floor 22 and an idle position in which it is at least partially removed from the raised floor 22, the face 400 of same being separated from the surface of the raised floor 22.

The attachment element 30 is held in place on the raised floor 22 by the attraction forces exerted between the magnet 40 and the sheet-metal floor 18 located beneath the raised floor 22.

The attachment element 30 also has a lever 42 having a first internal extremity 420, located inside the casing 32, and a second external free extremity 422, opposite the first extremity 420, pointing out of an opening 44 formed in the horizontal wall 320 and the peripheral wall 324, along an edge 322.

The free extremity 422 of the lever 42 is provided with gripping means 424.

Inside the casing 32, the internal extremity 420 of the lever 42 is linked to the side walls 324 of the casing 30 by means of a first transverse shaft 425 and to the edge 404 of the magnet 40 by means of a second transverse shaft 426. The edge 406 of the magnet 40 is linked to the side walls 324 of the casing 30 by means of a third transverse shaft 427.

Thus, when the magnet 40 is in the attached position, the lever 42 is in the “low” position, in which the free extremity 422 of the lever 42 is positioned close to a lower edge 44i of the opening 44. The lever 42 is then inclined in relation to the raised floor 22, the free extremity 422 of the lever 42 being further away from the raised floor 22 than the other extremity 420. The gasket 34 is then compressed against the upper face of the raised floor 22.

To move the magnet 40 from the attached position to the idle position in which it is separated from the raised floor 22, the free extremity 422 of the lever 42 is pulled upwards using the gripping means 424, causing the lever 42 to pivot about the axis 425 of same, which rotates the magnet 40 about the axis 427 of same by traction on the axis 426. The rotation of the lever 42 then lifts the edge 404 of the magnet 40 and rotates the magnet 40 upwards about the edge 406 of same.

When the magnet 40 is in the separated position, the lever 42 is in the “up” position in which the free extremity 422 is closer to an upper edge 44s of the opening 44 of the casing 32.

The strength of the magnet 40 is determined such that, when the lashing means 24 are configured for use, the attachment elements 30 cannot be detached from the surface of the raised floor 22, the tractive force being exerted essentially on the lashing ring 36 in a perpendicular, inclined or longitudinal direction in relation to the raised floor 22.

However, the device is designed such that the magnet 40 can be easily removed by exerting a small effort on the lever 42, the tractive force then being exerted off center on the magnet and in an oblique direction in relation to the raised floor 22.

According to a variant not shown here, means for locking the lever in the low position may be provided, comprising a pin assembled on a compressed spring designed to prevent the lever from going back up and to automatically engage the locking position when the lever is pushed down. To unlock the lever, the pin need simply be pulled out.

As shown in FIG. 5, in a second embodiment of the attachment element 30, the lashing ring is replaced by a supporting element 46 around which the strap 28, 28′ can be wound in order to facilitate the stowing of same when not in use.

As shown in FIG. 6, in another embodiment of the invention, the attachment element 30 does not have a lashing ring. The extremity 280, 280′ of the strap 28, 28′ includes a pin 48 designed to cooperate with an orifice 50 formed in the upper horizontal wall 320 of the casing 32. The orifice 50 has means for locking the pin 48 (not shown).

The lashing device according to the invention also has numerous advantages.

It is easy to use since the user need only lower the lever to lock the attachment means to the floor and to raise the lever to separate the attachment means from the raised floor.

It is very modular, since the attachment means can be positioned at any point of the raised floor, in order to adjust the device to the size of the item and the requirements of the user. It is also possible to use several lashing means.

Finally, it is very robust since the attachment means cannot be removed while the vehicle is moving.

1-11. (canceled)

12. An arrangement of a loading area inside a motor vehicle, comprising:
a raised floor extending above a sheet-metal floor of the vehicle; and
at least one lashing means comprising at least one attachment element to the raised floor, the attachment element being configured to be placed on the raised floor and comprising a permanent magnet configured to occupy a first position in which the attachment element is attached to the raised floor by magnetization and a second position in which the attachment element is separated from the raised floor.

13. The arrangement of the loading area as claimed in claim 12, wherein the attachment element includes:
a casing containing the magnet and having a horizontal upper wall extended by a substantially vertical lateral peripheral wall designed to be placed on the raised floor, and
a lever mounted rotatably between a high position and a low position and having a free extremity forming a gripping zone and an opposite extremity linked to a first transverse shaft carried by the peripheral wall of the casing,
the permanent magnet having a first edge linked to the extremity of the lever by a second transverse shaft and a second edge that is opposite the first edge and linked to the peripheral wall of the casing by a third transverse shaft such that, when the free extremity of the lever is turned upwards, a tractive force is applied to the second transverse shaft, which moves the magnet from the attached position, in which the lower face of same is in contact with the raised floor, to the separated position by means of a pivoting movement about the second edge of same and a raising of the first edge of same.

14. The arrangement of the loading area as claimed in claim 13, wherein the attachment element includes means for locking the lever in the low position.

15. The arrangement of the loading area as claimed in claim 14, wherein the casing has an opening configured to enable gripping means carried on the free extremity of the lever to pass through.

16. The arrangement of the loading area as claimed in claim 13, wherein a lower edge of the peripheral wall of the casing has a rubber gasket that can be pressed against the raised floor when the attachment element is in the fixed position.

17. The arrangement of the loading area as claimed in claim 12, wherein the lashing means are formed by a strap and extremities of the strap are attached to an attachment element.

18. The arrangement of the loading area as claimed in claim 17, wherein the casing includes hitching means for at least one of the extremities of the strap.

19. The arrangement of the loading area as claimed in claim 17, wherein the casing includes a strap-winding mechanism.

20. The arrangement of the loading area as claimed in claim 17, wherein the casing includes an orifice configured to receive a pin carried on one of the extremities of the strap

21. The arrangement of the loading area as claimed in claim 12, wherein the raised floor is made of a PTFE material configured to reduce adherence.

22. The arrangement of the loading area as claimed in claim 21, wherein a metal plate is positioned between the raised floor and the floor.
